(19) United States
(12) Patent Application Publication
(10) Pub. No.: US 2006/0290852 A1
(43) Pub. Date: Dec. 28, 2006

(54) Transflective LCD device with enhanced light transmittance

(75) Inventor: Ho Nam Yum, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/474,224

(22) Filed: Jun. 23, 2006

(30) Foreign Application Priority Data
Jun. 23, 2005 (KR) 2005-54299

(51) Int. Cl. G02F 1/1335

(52) U.S. Cl. 349/114

(57) ABSTRACT

A substrate assembly for a transflective LCD device includes an array panel and an optical path modifier disposed below the array panel. The array panel includes pixel areas that are each divided into reflective and transmissive areas by a reflective film formed therein. The optical path modifier includes first lens portions that correspond to the pixel reflective areas. Each first lens portion has a refractive index that decreases with increasing radial distance from an optical axis extending vertically through the midpoint of a boundary line between the corresponding pixel reflective and transmissive areas above it. Accordingly, light passing through the first lens portions is refracted through the corresponding pixel transmissive areas above. The display device also includes a backlight assembly for providing light to the display panel. The optical path modifier increases the light transmittance of the display device and the brightness of the images that it produces.

### RELATED APPLICATIONS

This application claims priority of Korean Patent Application No. 2005 0054299, filed Jun. 23, 2005, the disclosure of which is incorporated herein by reference in its entirety.

### BACKGROUND

The present invention relates to display devices in general, and in particular, to LCD devices having improved light transmittance.

Liquid crystal displays (LCDs) are one of the more widely used types of flat panel display devices. An LCD includes two transparent substrates provided with field-generating electrodes (i.e., a pixel electrode and a common electrode) and a liquid crystal (LC) layer interposed therebetween. The LCD displays images by applying voltages to the field-generating electrodes to generate an electric field in the LC layer, which controls the orientation of the LC molecules in the LC layer to effect the polarization of light passing through the layer.

LCDs can be categorized as operating in a “transmissive mode” or a “reflective mode,” depending on the source of light used by the LC layer to form an image. In particular, transmissive mode LCDs employ light supplied by an internal source, such as a “backlight” assembly contained in the display, whereas, reflective mode LCDs use light supplied by an external source, i.e., ambient light, such as sunlight, or ambient room lighting, as the light source. Generally, electronic devices such as watches and calculators that require low power consumption use reflective mode LCDs, whereas, notebook PCs and monitors requiring good image quality and having an adequate power supply use transmissive mode LCDs.

Certain mobile communication systems, such as cellular phones and PDAs, require display devices having both low power consumption and good image quality. To meet this requirement, so-called“transflective mode” LCDs have been developed. The transflective mode LCD operates in the reflective mode when the ambient light is sufficient to provide a useful display image, and when the ambient light is not sufficient to provide a useful image, activates an internal backlight assembly for operation in the transmissive mode.

Each pixel of a transflective mode LCD necessarily includes both a transmissive area and a reflective area. Thus, all other factors remaining the same, the transflective pixel has transmissive and reflective areas that are respectively smaller than those of a corresponding purely transmissive or purely reflective pixel. Accordingly, incident light from a backlight assembly will desirably pass through the transmissive area of the pixel, but will be inefficiently reflected back from the reflective area, whereas, incident ambient light will be desirably reflected back through the reflective area of the pixel, but will inefficiently pass through the transmissive area and into the display. As a consequence, the relative brightness of the transflective LCD is reduced and its image quality thereby deteriorated.

Accordingly, there is a long felt but as yet unsatisfied need in the LCD field for transflective mode-type LCDs that have improved light transmittance and reflectance properties.

### BRIEF SUMMARY

In accordance with the exemplary embodiments thereof described herein, the present invention provides a transflective mode LCD having substantially improved light transmittance and reflectance properties.

In one such exemplary embodiment, the improved LCD device comprises a substrate assembly that includes a generally planar array panel and a generally planar optical path modifier disposed below the array panel. The array panel includes a pixel area that is divided by a boundary line into a reflective area having a reflective film disposed therein, and an open, or transmissive area having no reflective film therein.

The optical path modifier includes a first lens portion corresponding in size and planar position to the pixel reflective area above it. The first lens portion has an optical axis that extends vertically through the midpoint of the boundary line between the pixel transmissive and reflective areas, and a refractive index that decreases with increasing radial distance from the optical axis thereof. The optical path modifier further includes a contiguous second lens portion disposed adjacent to the first lens portion and corresponding in size and planar location to the pixel transmissive area above it. The second lens portion has an optical axis that extends vertically through the center of the pixel transmissive area above it and a refractive index that decreases with increasing radial distance from the optical axis thereof.

In another exemplary embodiment, a transflective LCD substrate assembly includes a substrate having a plurality of pixel areas thereon, each having a thin film transistor (TFT), a transparent electrode, a reflective film and a lens region of a generally planar optical path modifier associated with it. The TFT is formed in the pixel area and the transparent electrode is located in the pixel area to receive a data signal from the TFT. The reflective film is formed on a portion of the transparent electrode and has an opening exposing a portion of the transparent electrode. The associated lens region of the optical path modifier is disposed below the pixel area and includes first and second lens portions, each corresponding in size and planar location to a respective one of the associated pixel reflective and transmissive areas above it. As above, each of the first and second lens portions has a respective refractive index that decreases with increasing radial distance from a respective optical axis thereof.

Another exemplary embodiment of a transflective LCD in accordance with the present invention includes a display panel, a backlight assembly, and a planar optical path modifier. The display panel includes reflective and transmissive areas, as above. The backlight assembly is disposed below the display panel and provides light to the display panel. The optical path modifier is interposed between the display and the backlight assembly, and as above, includes adjacent first and second lens portions respectively corresponding in size and planar position to the display panel reflective and transmissive areas directly above them, and having respective refractive indexes that decrease with increasing radial distance from respective optical axes thereof.

A better understanding of the above and many other features and advantages of the improved transflective LCDs of the present invention may be obtained from a consideration of the detailed description of the exemplary embodiments thereof below, particularly if such consideration is made in conjunction with the several views of the appended drawings, wherein like reference numerals are used to identify like elements illustrated in one or more of the figures thereof.

### BRIEF DESCRIPTION OF THE DRAWINGS

FIG. 1 is a partial cross-sectional view of a first exemplary embodiment of a transflective LCD substrate assembly in accordance with the present invention;

FIG. 2 is a graph of the refractive index of first and second lens portions of an optical path modifier of the substrate assembly of FIG. 1;

FIG. 3 is a partial upper side perspective view of the substrate assembly of FIG. 1, illustrating a portion of an array panel thereof disposed above and spaced apart from a portion of an optical path modifier thereof;

FIG. 4 is another partial cross-sectional view of the substrate assembly of FIG. 1, illustrating a vertical spacing between the array panel and the optical path modifier thereof;

FIG. 5 is a partial cross-sectional view of a second exemplary embodiment of an LCD substrate assembly in accordance with the present invention;

FIG. 6 is a partial cross-sectional view of a third exemplary embodiment of an LCD substrate assembly in accordance with the present invention;

FIG. 7 is a graph of the refractive index of first and second lens portions of an optical path modifier of the substrate assembly of FIG. 6;

FIG. 8 is an enlarged detail view of the portion of an optical path modifier encircled by the dashed line “E” in FIG. 6;

FIG. 9 is a partial plan view of a fourth exemplary embodiment of an LCD substrate assembly in accordance with the present invention, illustrating a plurality of pixel areas thereof;

FIG. 10 is a cross-sectional view of the substrate assembly of FIG. 9, as seen along the section lines I-I′ taken therein;

FIG. 11 is a partial cross-sectional view of a fifth exemplary embodiment of an transflective LCD device in accordance with the present invention, illustrating a transmissive mode of operation thereof; and, FIG. 12 is a partial cross-sectional view of the transflective LCD device of FIG. 11, illustrating a reflective mode of operation thereof.

### DETAILED DESCRIPTION

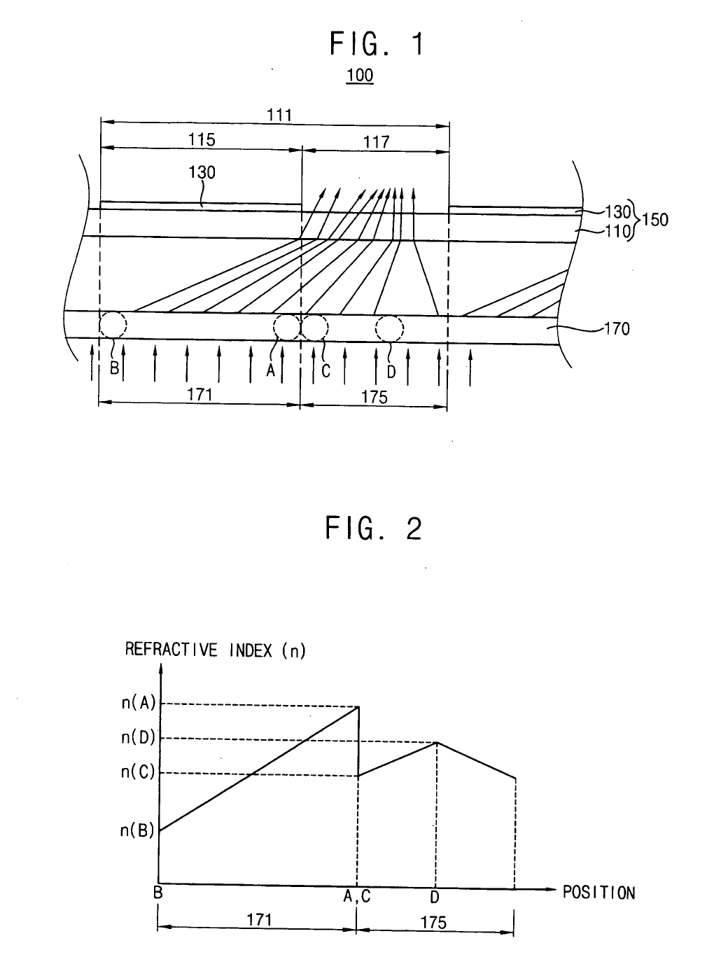

FIG. 1 is a partial cross-sectional view of an exemplary first embodiment of a substrate assembly 100 for a transflective LCD in accordance with the present invention. The substrate assembly 100 includes an array panel 150 and a generally planar optical path modifier 170 disposed below the array panel. The array panel 150 comprises a transparent substrate 110 having a reflective film 130 formed on selected areas thereof to define a plurality of pixel areas 111 thereon. The reflective film 130 has openings 117 that divide each pixel area 111 into a reflective area 115 and a transmissive area 117 that are separated from each other by a boundary line A.

In operation, the optical path modifier 170 receives light from an internal, underlying light supplier (not illustrated) and selectively directs the light toward the transmissive areas 117 of the pixel areas above it. Thus, the optical path modifier 170 changes the optical path of the light that would otherwise be incident upon the lower surfaces of the pixel reflective areas 115 of the array panel and guides it into the pixel transmissive areas 117 of the array panel in the manner described below.

As illustrated in FIG. 1, the optical path modifier 170 includes a plurality of continuous light collecting, or lens regions corresponding to each of the pixel areas 111 of the array panel 150 above it. Each lens region includes first and second lens portions 171 and 175 disposed immediately adjacent to and contiguous with each other. The first lens portion 171 is disposed directly below and corresponds in size and planar location to the pixel reflective area 115 above it, and the second lens portion 175 is disposed directly below and corresponds in size and planar location to the pixel transmissive area 117 above it. As indicated in the figure, four boundary lines A, B, C, and D are defined within the lens region, viz., a boundary line A defined between the first and second lens portions 171 and 175, a second boundary line B defined between the first lens portion 117 and an adjacent lens region, a third boundary line C immediately adjacent to the boundary line A, and a central boundary line D corresponding to the center of the second lens portion 175 of the lens region.

FIG. 2 is a graph of the refractive index n of the optical path modifier lens region of FIG. 1 at every lateral position between the boundary line B and the corresponding boundary line of the next adjacent lens region to its right. As may be seen by reference to the figure, the refractive index n of the first lens portion 171 decreases continuously as a function of the distance between the boundary line B and the boundary line A between the two lens portions 171 and 175. Accordingly, although the first lens portion 171 is generally planar in shape, it functions as a half-portion of a rectangular convex lens having an optical axis located at the mid-point of the boundary line A to collect incident light and refract it toward a focus at the right side of the first lens portion. Thus, a light ray entering the first lens portion 171 will be refracted at an angle that depends on the radial distance from the optical axis of the point at which the light ray enters the first lens portion 171, thereby causing the light ray to be transmitted to the pixel transmissive area 117 located above and adjacent to the first lens portion, rather than to the pixel reflective area 115 located directly above it.

FIG. 2 also graphically illustrates the refractive index n of the second lens portion 175 as a function of the lateral position within the second portion. As illustrated in the figure, the refractive index n increases continuously between the boundary line C and the center boundary line D, then decreases continuously between the center boundary line D and the boundary line B of the next adjacent lens region to the right. Accordingly, although the second lens portion 175 also has a flat, planar shape, it likewise functions as a rectangular convex lens having an optical axis extending vertically through the midpoint of the center boundary line D to collect light incident upon the second lens portion and focus it through the center of the pixel transmissive area 117 located directly above it.

As may also be seen by reference to the graph of FIG. 2, the difference between the respective refractive indexes n(A) and n(B) at the boundary lines A and B of the lens region is larger than the difference between the respective refractive indexes n(D) and n(C) at the boundary lines D and C.

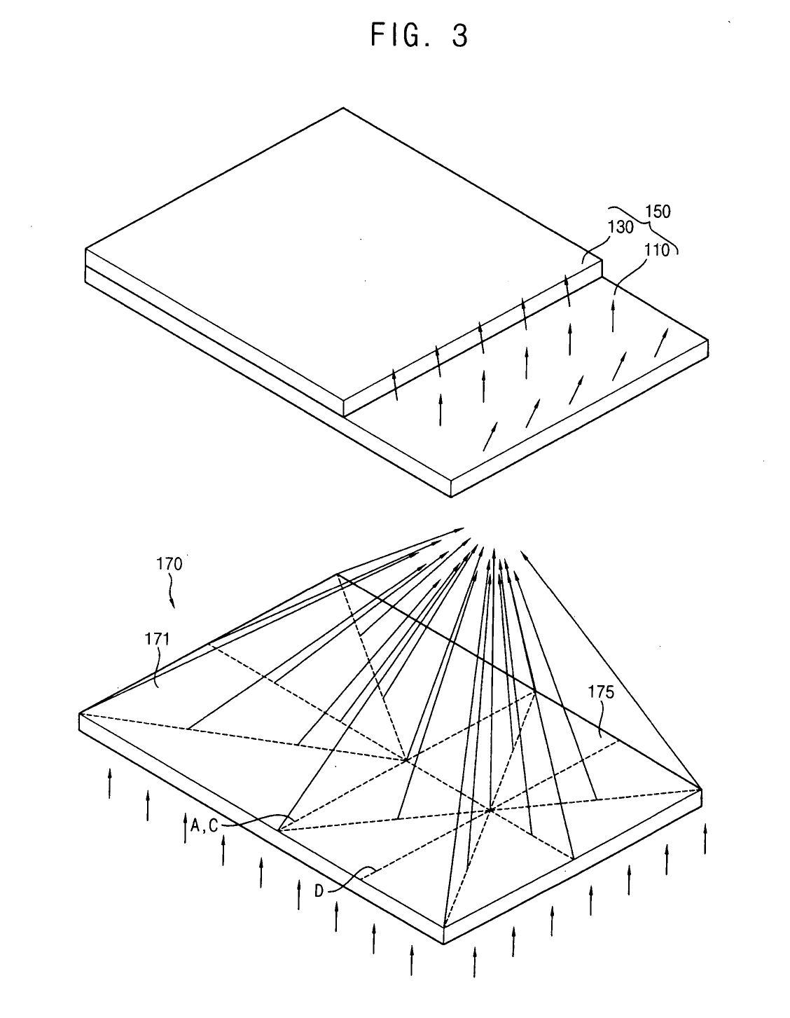

FIG. 3 is a perspective view of the substrate assembly of FIG. 1, with the array panel 150 portion shown spaced apart from the corresponding lens region 170 to illustrate how the latter functions to collect and focus light through the transmissive area 175 of the former. As described above, the refractive index n of the first lens portion 171 decreases with increasing radial distance from the optical axis of the first lens portion, which extends vertically through the midpoint of the boundary line A, and accordingly, has a value that is constant along half-circles (or in the case of a rectangular lens portion, half-ellipses) that are concentric to the optical axis. Accordingly, light passing through the first lens portion 171 is refracted toward a focal point located along the optical axis of the first lens portion to pass through the pixel transmissive area 117 located above and adjacent to the first lens portion. Similarly, light passing through the second lens portion 175 is refracted toward a focal point located along the optical axis of the second lens portion, which extends vertically through the midpoint of the boundary line D, to pass through the transmissive area 117.

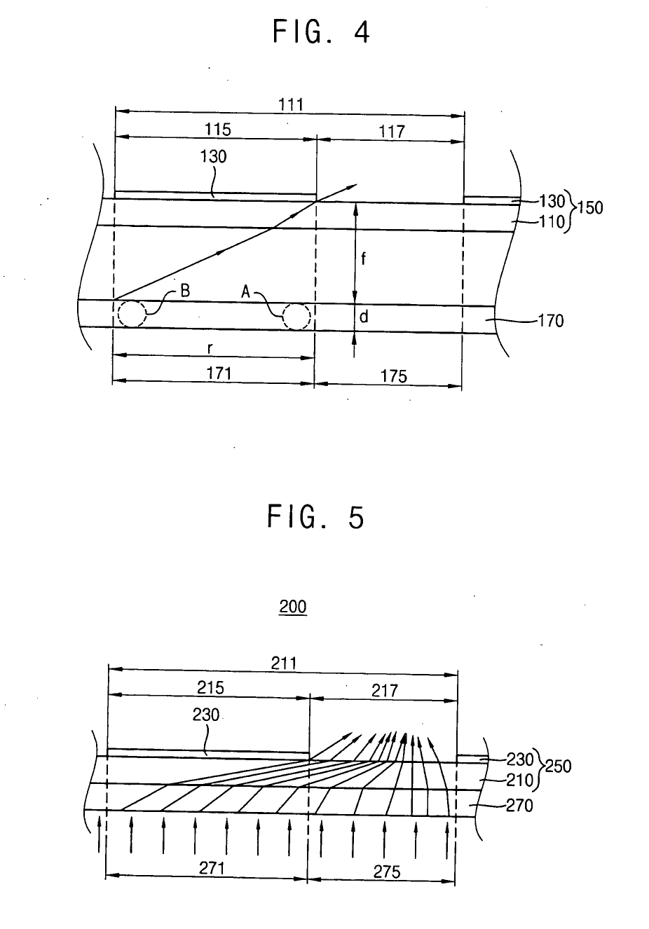

FIGS. 4 and 5 are partial cross-sectional views of the substrate assembly of FIG. 1, respectively illustrating the effect of vertical spacing between the array panel 150 and the optical path modifier 170. With reference to FIG. 4, the upper surface of the first lens portion 171 is spaced apart from the reflective film 130 by a distance f corresponding to the focal length of the first lens portion 171. As discussed above, the optical axis of the first lens portion 171 is located at the midpoint of the boundary line A of the first lens portion 171. The refractive index n(r) of the first lens portion 171 at a radial distance r from the optical axis at A thus satisfies the equation,

$$n ( r ) = n ( max ) - \frac{{r}^{2}}{2 fd} ,$$

where n(max) is the maximum refractive index (i.e., the refractive index at the midpoint of the boundary line A), f is the focal length, and d is the thickness of the first lens portion 171.

As will be appreciated, the distance between the array substrate 150 and the optical path modifier 170 can be adjusted to be either larger or smaller than the focal length f of the first lens portion 171, thereby causing greater or lesser amounts of light passing through the first lens portion to be refracted through the pixel transmissive area 117 above and adjacent to it. Thus, by adjusting 1) the spacing between the array panel 150 and the optical path modifier 170, 2) the maximum refractive index n(max), and 3) the gradient of the refractive index n of the first lens portion 171 as a function of the radial distance from the optical axis, the amount of light passing through the first lens portion and refracted through the transmissive area 117 can be maximized.

FIG. 5 is a partial cross-sectional view of a second exemplary embodiment of a transflective LCD substrate assembly 200 which is identical to the substrate assembly 100 of first embodiment above, except that the array panel 250 is disposed directly on top of the optical path modifier 270, i.e., such that there is no spacing between the two components. In such an embodiment, the spacing between the two components is fixed, and is less than the component spacing of the first embodiment of FIG. 4 above. Hence, the option of varying the spacing between the two components to maximize light transfer is not available, and accordingly, it may be necessary in such an embodiment to increase the thickness d of the optical path modifier 270 of the second embodiment to make it thicker than the optical path modifier 170 of the first embodiment above in order to secure a sufficient effective distance between the two components to achieve an optimal refraction of light through the transmissive area 217.

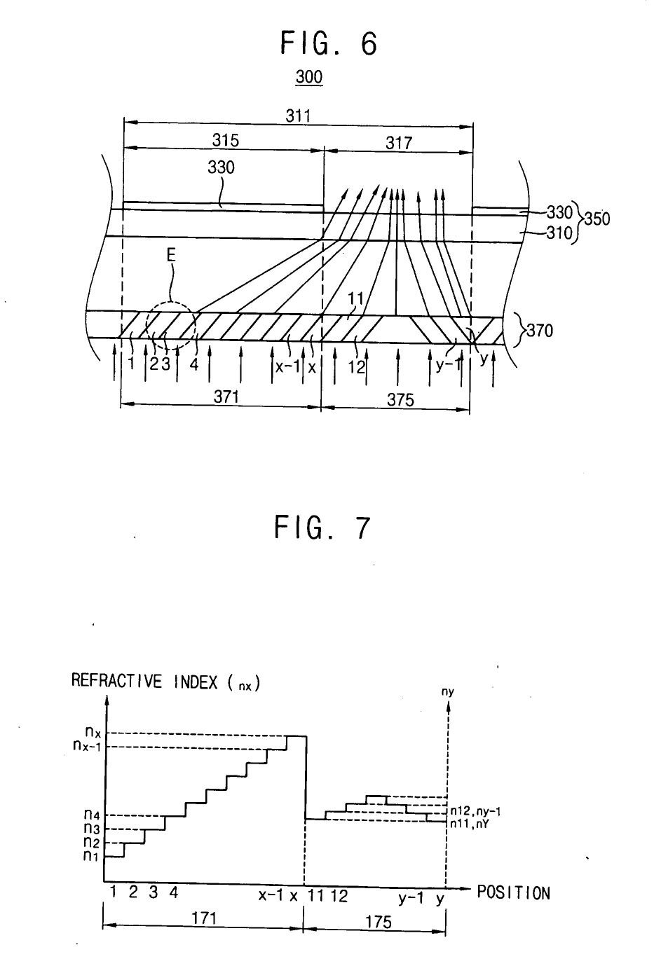

FIG. 6 is a partial cross-sectional view of a third exemplary embodiment of an LCD substrate assembly in accordance with the present invention. The substrate assembly 300 of the third embodiment is identical to the substrate assembly 100 of the first embodiment above, except for the configuration of the optical path modifier 370 thereof.

With reference to FIG. 6, and as in the above exemplary embodiments, the optical path modifier 370 includes a first lens portion 371 and a second lens portion 375, with the first lens portion 371 being disposed directly below a reflective area 315 of an array panel 350, and the second portion 375 being disposed directly below the transmissive portion 317 thereof. However, unlike the above embodiments, the first lens portion 371 comprises a plurality of discrete first lens elements (1, 2, 3, . . . x−1, x), and the second lens portion 375 comprises a plurality of discrete second lens elements (11, 12, . . . , y−1, y). The respective lens elements of the two lens portions are disposed adjacent to and contiguous with each other to form a continuous, planar structure having a plurality of interfaces therebetween. As illustrated in the figure, the interfaces between the elements of the first portion 371 all incline toward the second lens portion 375 and form acute angles with the upper and lower surfaces of the optical path modifier 370, while the interfaces of the second portion 375 incline symmetrically toward the optical axis at the center of the second lens portion 375.

As those of skill in the art will appreciate, the interfaces between the respective lens elements x and y form the refractive surfaces of a Fresnel lens, and thus, it may be seen that the two lens portions 371 and 375 form a pair of adjacent, contiguous Fresnel lenses disposed below the pixel area 311 of the array panel 350.

FIG. 7 is a graph illustrating the refractive index of the optical path modifier region of FIG. 6 as a function of lateral position. As may be seen by reference to FIGS. 6 and 7, each of the first and second lens elements (1, 2, 3, . . . , x−1, x) and (11, 12, . . . , y−1, y) has a constant refractive index (n1, n2, n3, . . . , nx−1, nx) and (n11, n12, . . . , ny−1, ny), respectively, thereby resulting in a graph having a characteristic stepped appearance. Additionally, the respective refractive indexes (n1, n2, n3, . . . , nx−1, nx) of the first lens elements increase monotonically as their respective lateral position approaches the boundary line between the first and second lens portions 371 and 375. Thus, the lens element x disposed immediately adjacent to the second lens portion 375 has a maximum refractive index of nx, while the first lens element 1 has a minimum refractive index of n1.

Additionally, it may be seen that the respective refractive indexes (n11, n12, . . . , ny−1, ny) of the second lens elements (11, 12, . . . , y−1, y) become larger as their respective lateral positions approach the center of the second lens portion 375, and further, that the maximum refractive index nx of the first lens elements (1, 2, 3, . . . x−1, x) is larger than the maximum refractive index of the second lens elements, whereas, the minimum refractive index of the first lens elements is less than the minimum refractive index of the second lens elements.

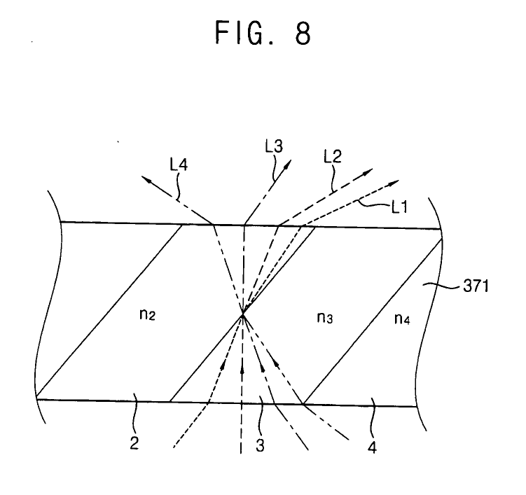

FIG. 8 is an enlarged detail view of the portion of the optical path modifier 370 of FIG. 6 outlined by the circular dashed line “E”. With reference to FIGS. 6 and 8, it may be seen that light rays L1-L4 entering the lens element 3 pass through the interface between the lens element 3 (having a refractive index n3) and the lens element 2 (having a smaller refractive index n2) and are refracted twice, first at the interface between the two lens elements, and then at the interface between the upper surface of the lens element 2 and ambient air. Additionally, as the slope of the interface between the lens elements decreases, the difference in the respective refractive indexes of the two lens elements increases, and accordingly, the angle of refraction of the light rays likewise increases.

Thus, while a large proportion of the light rays entering the first lens portion 371, e.g., L1, L2, and L3, are refracted toward the pixel transmissive area 317 above, a small portion of the light, e.g., light ray L4, may be inefficiently refracted toward the reflective or transmissive areas of an adjacent pixel (not illustrated). However, because the second lens portion 375 is centered directly below the pixel transmissive area 317, substantially all of the light entering the second lens portion 375 is refracted toward the transmissive area 317.

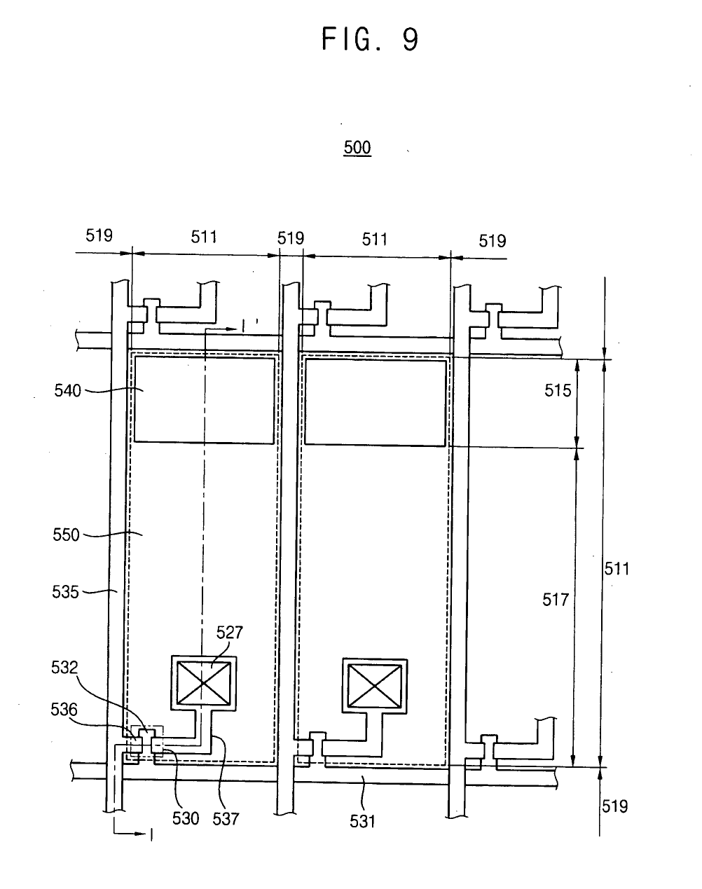

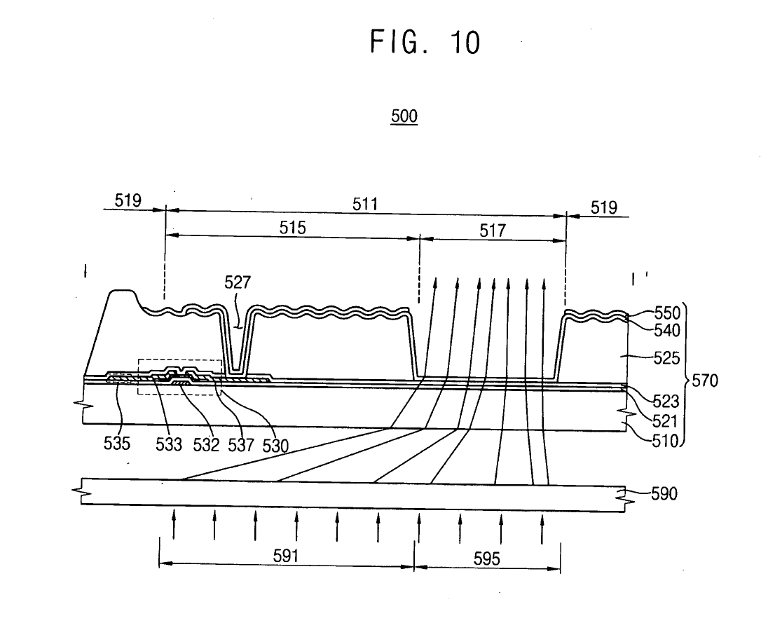

FIG. 9 is a partial plan view of a fourth exemplary embodiment of a transflective LCD substrate assembly 500 in accordance with the present invention, and FIG. 10 is a cross-sectional view taken along the section lines I-I′ therein. With reference to FIGS. 9 and 10, the substrate assembly 500 includes an array panel 570 and an optical path modifier 590. The array panel 570 includes an optically transparent insulating substrate 510, such as glass, and respective pluralities of thin film transistors (TFTs) 530, transparent electrodes 540, and reflective films 550.

A plurality of pixel areas 511 is defined on the insulating substrate 510 within the respective interstices of a grid of peripheral areas 519, which form boundary areas between adjacent pixel areas 511. As in the embodiments described above, each pixel area 511 is divided into a reflective area 515 and a transmissive area 517. The array panel 570 further includes a plurality of first signal lines 531, a first insulating layer 521, and a plurality of second signal lines 535 arranged generally orthogonal to the first signal lines. The first signal lines 531 are formed on the insulating substrate 510, and the first insulating layer 521 is formed over the first signal lines 531 and the insulating substrate 510. The first insulating layer 521 comprises an electrical insulator, such as silicon nitride (SiNx) or silicon oxide (SiOx), and functions to insulate the second signal lines 535 from the first signal lines 531. The second signal lines 535 are formed over the first signal lines 531 and the first insulating layer 521 such that each pixel area 511 is defined by an associated pair of the orthogonal first and second signal lines 531 and 535.

Each of the TFTs 530 is formed in a corresponding one of the reflective areas 515 of the associated pixel areas 511, and includes a source electrode 536, a gate electrode 532, a drain electrode 537, and a semiconductor layer 533. The gate electrode 532 is formed simultaneously with and electrically connected to the associated first signal line 531. The source electrode 536 and the drain electrode 537 are formed simultaneously with the associated second signal line 535. The source electrode 536 is connected to the associated second signal line 535, and the drain electrode 537 is spaced apart from the source electrode 536 and connected to the associated transparent electrode 540, as illustrated in FIGS. 9 and 10.

Data driving circuits (not illustrated) are respectively connected to the second signal lines 535 and output respective data signals that are applied to the source electrodes 536 through the second signal lines 535. Also, scanning driving circuits (not illustrated) are respectively connected to the gate electrodes 532 and output respective scanning signals that are applied to the gate electrodes 532. In response to the respective scanning signals, the respective data signals are applied to the respective drain electrodes 537, and hence, to the respective transparent electrodes 540.

As illustrated in FIG. 10, a passivation layer 523 is formed over the TFTs 530 and the first insulating layer 521, and a second insulating layer 525 is formed over the passivation layer 523. The passivation layer 523 can be formed of an electrical insulator, such as silicon nitride SiNx or silicon oxide SiOx. The passivation layer 523 and the second insulating layer 525 have contact holes 527 formed therein to expose a portion of the drain electrodes 537 lying below. The second insulating layer 525 is selectively removed from areas corresponding to the transmissive areas 517, and is left remaining in areas corresponding to the reflective areas 515.

The transparent electrodes 540 are formed over the second insulating layer 525, the passivation layer 523, and the drain electrodes 537. The transparent electrodes 540 comprise an optically transparent, electrically conductive material, such as indium tin oxide (ITO), indium zinc oxide (IZO), or zinc oxide (ZO).

The reflective film 550 is formed on areas of the second insulating layer 525 corresponding to the reflective areas 515 to reflect ambient light incident on the panel. In one exemplary embodiment, the second insulating layer 525 can be formed with a dimpled, uneven upper surface, and the reflective film 550 conformingly formed on the uneven surface so as to reflect incident ambient light in a random, diffuse manner. The reflective film 550 is made of an electrically conductive material to connect to the associated drain electrode 537 through the transparent electrode 540. The pixel areas 511 are thus divided into the reflective areas 511 and the transmissive areas 517 by the presence or absence of the reflective film 550.

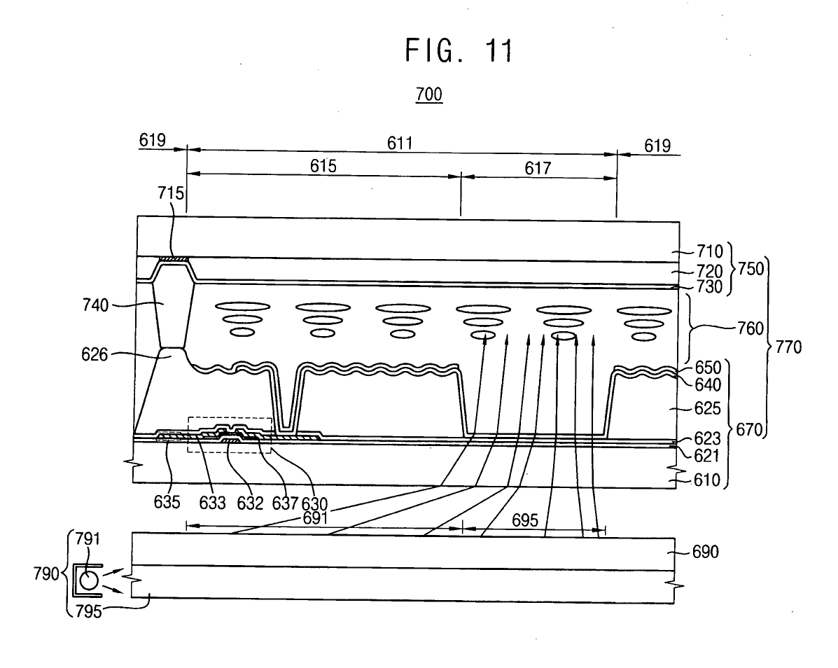

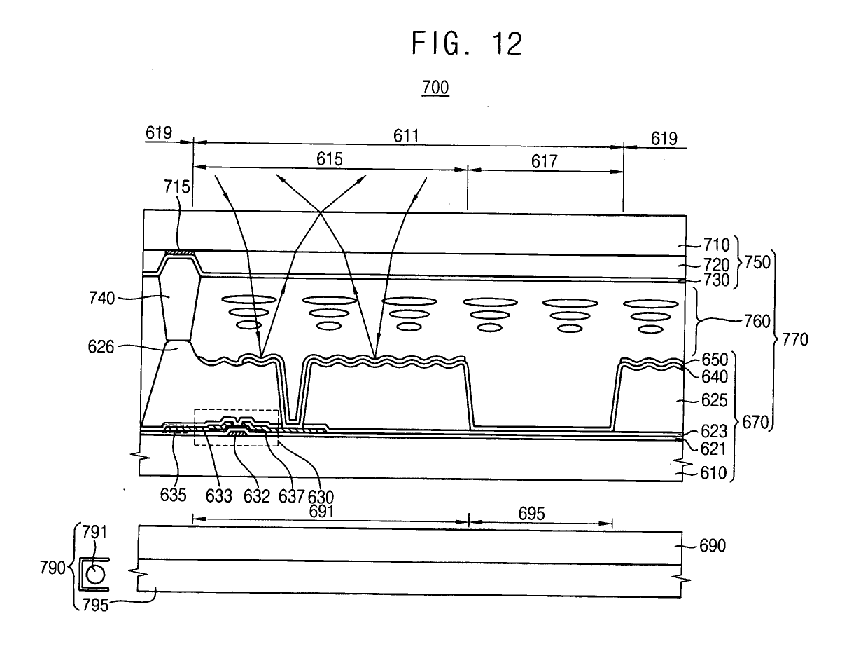

FIG. 11 is a partial cross-sectional view of a fifth exemplary embodiment of a transmissive LCD device 700 in accordance with the present invention, illustrating a transmissive mode of operation thereof, and FIG. 12 is a partial cross-sectional view of the LCD device of FIG. 11, illustrating a reflective mode of operation thereof.

Referring to FIGS. 11 and 12, the display device 700 includes a panel assembly 770, a backlight assembly 790, and an optical path modifier 690. The panel assembly 770 includes an array panel 670, a counter panel 750, and liquid crystal layer 760 disposed therebetween. The array panel 670 includes an optically transparent, electrically insulating substrate 610, upon which respective pluralities of TFTs 630, transparent electrodes 640, and reflective films 650 are arrayed. The array panel 670 also includes pixel areas 611 and peripheral areas 619 surrounding the pixel areas 611. Each pixel area 611 includes a transmissive area 617 and a reflective area 615, and the transmissive areas 617 are rectangular in shape. The array panel 670 is thus substantially identical to that shown in FIGS. 9 and 10 and described above, and accordingly, further description of these is omitted here for brevity.

The second insulating layer 625 of the array panel 670 comprises protruding portions 626 and uneven or dimpled upper surfaces disposed in the reflective areas 615 of the panel. The reflective film 650 is formed on the surface to enhance the reflective efficiency thereof. A plurality of spacers 740 is selectively disposed on the protruding portions 626 to maintain the spacing between the array panel 670 and the counter panel 750.

The counter panel 750 is disposed over the array panel 670 with a liquid crystal layer 760 disposed therebetween. The counter panel 750 is divided into transparent display areas corresponding to the pixel areas 611 of the array panel 670, and opaque areas corresponding to peripheral areas 619 thereof. The counter panel 750 includes a transparent upper substrate 710, a black matrix 715, a plurality of color filters 720, a common electrode 730, and the spacers 740.

The upper substrate 710 of the counter panel 750 is made of an optically transparent material, such as glass. Both the insulating substrate 610 of the array panel 670 and the upper substrate 710 of the counter panel 750 can be made of polycarbonate (PC), polyethersulfone (PES), polyethylene terephthalate (PET), polyvinyl alcohol (PVA), polyethylene naphthalate (PEN), polyvinyl alcohol (PVA), polymethylmethacrylate (PMMA), or cyclo-olefin polymer (COP). Preferably, both the upper substrate 710 and the insulating substrate 610 exhibit isotropic optical properties.

The black matrix 715 is formed in areas of the panel through which it is desirable to block the passage of light. The black matrix 715 thus prevents light from entering or leaving the areas of the panel in which the orientation of the liquid crystal molecules cannot be controlled. The black matrix 715 can be formed of a metal, such as chromium (Cr), or a metal compound, such as chrome oxide (CrOx) or chrome nitride (CrNx), or alternatively, of an opaque organic material, such as carbon black and certain pigment or dye compounds. The pigment and dye compounds can include red, green and blue pigments and dyes. In one possible embodiment, the black matrix 715 can be formed by depositing an opaque photoresist material and then patterning the material with a photolithographic process. The black matrix 715 can also be formed by overlapping a plurality of the color filters 720.

The color filters 720 are formed in the display areas of the counter panel 750 and selectively transmit light having a specific wavelength, ie., those corresponding to red, green, and blue (RGB) colors. In an alternative embodiment, the color filters 720 can be formed on respective areas of the passivation layer 623 of the array panel 670.

The common electrode 730 is formed over the entire lower surface of upper substrate 710 after the formation thereon of the black matrix 715 and the color filters 720. The common electrode 730 is formed of a transparent, electrically conductive material, such as indium tin oxide (ITO), indium zinc oxide (IZO), or zinc oxide (ZO). In another possible embodiment, the common electrode 730 can be disposed on the insulating substrate 610 of the array panel 670 in parallel with the transparent electrode 640 and the reflective film 650.

The spacers 740 are disposed on the common electrode 730 in locations corresponding to the black matrix 715 to maintain the desired spacing between the array panel 670 and the counter panel 750. In the particular embodiment illustrated in FIGS. 11 and 12, the spacers 740 are column-type spacers that are formed at specific locations by a patterning process. However, in an alternative embodiment (not illustrated), the spacers 740 can comprise spherical, or ball-type spacers that are placed by scattering, or alternatively, can comprise a mixture of ball-type and column-type spacers.

The periphery of the liquid crystal layer 760 interposed between the array panel 670 and the counter panel 750 is sealed by a sealant (not illustrated) to prevent its escape from the panel. The molecules of the liquid crystal material can assume a variety of orientations, depending on the mode of liquid crystal operation selected, such as twisted nematic (TN), vertical alignment (VA), mixed twisted nematic (MTN), or homogeneous modes.

The array panel 670 and the counter panel 750 can include alignment films (not illustrated) to align the liquid crystal molecules, and can also include storage capacitors (not illustrated) for maintaining the respective voltages between the respective transparent electrodes 640 and the common electrode 730. The respective voltages applied between the transparent electrodes 640 and the common electrode 730 generate an electric field in the liquid crystal layer 760 that determines the orientation of the molecules in the portion of the layer 760 associated with the transparent electrodes 640 to adjust the polarization of incident light passing therethrough. Light is transmitted through the liquid crystal layer 760 via two optical paths. In a “transmissive” one of these, light generated by an internal light source, such as the backlight assembly 790 described below, enters the panel assembly 770 through the lower surfaces of the transmissive areas 617 of the array panel 670 and passes through the liquid crystal layer 760 above, as illustrated in FIG. 11. In the other, “reflective” path, external ambient light enters the panel assembly 770 through the upper surface of the counter panel 750 and is reflected back from the reflective film 615 through the liquid crystal layer 760 and counter panel 750, as illustrated in FIG. 12.

As illustrated in FIGS. 11 and 12, the backlight assembly 790 is disposed below the display panel 770 to provide an internal source of light to the display panel 770 when the display device 700 operates in a transmissive mode. The backlight assembly 790 includes a light source 791 and an optical unit 795. The light source 791 is disposed adjacent to the optical unit 795 and provides light to the latter. The optical unit 795 adjusts the distribution, direction and intensity of the light supplied by the light source 791 to the display panel 770.

As illustrated in the figures, the optical path modifier 690 is interposed between the display panel 770 and the backlight assembly 790. In the particular exemplary embodiment illustrated in FIGS. 11 and 12, the optical path modifier 690 is a film-type modifier that is spaced apart from the display panel 770. However, in another possible embodiment, the optical path modifier can be integral with the array panel 670.

As in the exemplary embodiments described above, the optical path modifier 690 includes first and second lens portions 691 and 695 respectively corresponding to the pixel reflective and transmissive areas 615 and 617 disposed above them. Each of the first lens portions 691 is configured such that the refractive index at any position therein decreases continuously as a function of the radial distance of the position from a vertical optical axis at the midpoint of the boundary line between the two lens portions 690 and 695. As a result, substantially all of the light from the light source 791 that passes through first lens portion 691 is refracted through the transmissive area 617 above and adjacent to the first lens portion.

Each of the second lens portions 695 is configured such that the refractive index at any position therein decreases continuously as a function of the radial distance of the position from a vertical optical axis at the center of the portion, such that substantially all of the light from the backlight assembly 790 that passes the second lens portion 795 is also refracted through the transmissive area 617 directly above the second lens portion.

In accordance with the exemplary embodiments of the present invention described and illustrated herein, an optical path modifier of a transflective LCD device modifies the path of light from an internal light source that would otherwise be ineffectively incident upon reflective areas of an array panel thereof and guides the light toward transmissive areas of the array panel, thereby reducing light losses and increasing the light transmittance of the LCD. As a result of the increased light transmittance, the reflective areas of the panel can be made larger without loss of light transmittance, thereby improving both light reflectance and transmittance of the device and reducing the amount of power necessary to produce a given level of display image brightness.

As those of skill in this art will appreciate, many modifications, substitutions and variations can be made in the materials, apparatus, configurations and methods of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. An LCD substrate assembly, comprising:
a generally planar array panel having a pixel area,
wherein the pixel area is divided by a boundary line into a transmissive area and a reflective area having a reflective film disposed therein; and,
a generally planar optical path modifier disposed below the array panel and comprising a first lens portion corresponding in size and planar position to the pixel reflective area,
wherein the first lens portion has an optical axis that extends vertically through the midpoint of the boundary line between the pixel transmissive and reflective areas above, and a refractive index that decreases with increasing radial distance from the optical axis thereof.

2. The substrate assembly of claim 1, wherein the optical path modifier further comprises a second lens portion disposed adjacent to and contiguous with the first lens portion and corresponding in size and planar position to the pixel transmissive area.

3. The substrate assembly of claim 2, wherein the second lens portion has an optical axis that extends vertically through the center of the pixel transmissive area above and a refractive index that decreases with increasing radial distance from the optical axis thereof.

4. The substrate assembly of claim 3, wherein the difference between a maximum and a minimum value of the refractive index of the first lens portion is larger than the difference between a maximum and a minimum value of the refractive index of the second lens portion.

5. The substrate assembly of claim 3, wherein the refractive index at the optical axis of the first lens portion is larger than the refractive index at the optical axis of the second lens portion.

6. The substrate assembly of claim 3, wherein the first lens portion comprises a plurality of first lens elements having interfaces therebetween, and wherein the interfaces form acute angles with upper and lower surfaces of the optical path modifier.

7. The substrate assembly of claim 6, wherein each first lens element has a constant refractive index, and wherein the respective refractive indexes of first lens elements decrease with increasing radial distance from the optical axis of the first lens portion.

8. The substrate assembly of claim 3, wherein the second lens portion comprises a plurality of second lens elements having interfaces therebetween, and wherein the interfaces incline toward the optical axis of the second lens portion.

9. The substrate assembly of claim 8, wherein each second lens element has a constant refractive index, and wherein the respective refractive indexes of the second lens elements decrease with increasing radial distance from the optical axis of the second lens portion.

10. The substrate assembly of claim 1, wherein the optical path modifier is spaced apart from the array panel.

11. The substrate assembly of claim 1, wherein the optical path modifier is integral with the array panel.

12. An LCD substrate assembly, comprising:
a substrate having a plurality of pixel areas;
a thin film transistor formed in each of the pixel areas;
a transparent electrode located in each of the pixel areas and arranged to receive a data signal from an associated one of the thin film transistors;
a reflective film formed on a portion of an associated one of the transparent electrodes and having an opening exposing a portion of the associated transparent electrode; and,
a generally planar optical path modifier disposed below the substrate and having adjacent first and second lens portions associated with each of the pixel areas,
wherein each of the first lens portions has a respective refractive index that decreases with increasing distance from a boundary line between the first and the adjacent second lens portion.

13. The substrate assembly of claim 12, further comprising:
first signal lines formed on the substrate and arranged to transmit respective selection signals to associated ones of the thin film transistors;
a first insulating layer formed on the first signal line; and,
second signal lines formed on the first insulating layer and arranged generally orthogonally to the first signal lines to transmit respective data signals to associated ones of the thin film transistors in response to the selection signals.

14. The substrate assembly of claim 12, wherein each of the pixel areas includes a reflective area corresponding to the reflective film therein and a transmissive area corresponding to the opening of the reflective film.

15. The substrate assembly of claim 14, wherein each of the first and second lens portions of the optical modifier respectively corresponds in size and planar position to the reflective and transmissive areas of the associated pixel above.

16. A display device, comprising:
a display panel including multiple pairs of adjacent reflective and transmissive areas and configured to display images;
a generally planar backlight assembly disposed below the display panel and configured to transmit light through the display panel; and,
a generally planar optical path modifier interposed between the display panel and the backlight assembly and including first lens portions, each associated with a respective pair of the adjacent reflective and transmissive areas of the display panel and corresponding in size and planar position to the reflective area thereof,
wherein each of the first lens portions has an optical axis extending vertically through the midpoint of a boundary line between the reflective and transmissive areas of the associated pair thereof and a refractive index that decreases with increasing radial distance from the optical axis.

17. The display device of claim 16, wherein the optical path modifier further comprises second lens portions, each respectively associated with a pair of the adjacent reflective and transmissive areas and corresponding in size and planar position to the transmissive area thereof and configured to refract light provided by the backlight assembly toward the transmissive area.

18. The display device of claim 17, wherein of the second lens portion has a refractive index that decreases with increasing radial distance from the center of the second lens portion.

19. The display device of claim 16, wherein the backlight assembly comprises:
a light source; and,
a generally planar optical unit disposed adjacent to the light source and configured to distribute and guide light emitted from the light source toward the display panel.

20. The display device of claim 16, wherein the display panel comprises:
an array panel disposed above the optical path modifier and including pixel areas, each divided into an associated pair of the adjacent reflective and transmissive areas;
a counter panel facing the array panel; and,
a liquid crystal layer interposed between the array panel and the counter panel.

21. The display device of claim 20, wherein the array panel further comprises:
an insulating substrate;
a thin film transistor formed on the insulating substrate;
an insulating layer formed over the insulating substrate and having different thicknesses in areas corresponding to the reflective and transmissive areas;
a transparent electrode formed on the insulating layer and connected to the thin film transistor; and,
a reflective film formed on the transparent electrode and having an opening exposing the transparent electrode.
